(19) United States
(12) Patent Application Publication
(10) Pub. No.: US 2024/0062544 A1
(43) Pub. Date: Feb. 22, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Haruna WATANABE, Tokyo (JP); Soma SHIRAISHI, Tokyo (JP); Yu NABETO, Tokyo (JP)

(73) Assignee: NEC Corporation, Minato-ku, Tokyo (JP)

(21) Appl. No.: 18/270,283

(22) PCT Filed: Jan. 6, 2021
(86) PCT No.: PCT/JP2021/000214

§ 371 Date: Jun. 29, 2023

(51) Int. Cl. G06V 20/40

(52) U.S. Cl. CPC G06V 20/44; G06V 20/49

(57) ABSTRACT

In an information processing device, an acquisition means acquires a plurality of videos including a video material and a digest video. A coincident segment detection means detects each coincident segment where the video material and the digest video match with each other in content. A training data generation means generates training data from the video material based on the coincident segment.

### TECHNICAL FIELD

The present disclosure relates to processing of video data.

### BACKGROUND ART

Techniques for generating a video digest from video images have been proposed. Patent Document 1 discloses a highlight extraction device in which a learning data file is created from video images for training prepared in advance and video images for an important scene specified by a user, and the important scene is detected from target video images based on the learning data file.

### PRECEDING TECHNICAL REFERENCES

### Patent Document

Patent Document 1: Japanese Laid-open Patent Publication No. 2008-022103

### SUMMARY

### Problem to be Solved by the Invention

In a case of creating a digest video by extracting parts of a video material where some kind of event occurred, it is desirable to successfully clip the entire individual events and include these events in the digest video. For example, in a case of extracting a part where a batter hits a home run as an event from the video material of a baseball game, it is preferable to extract not only a scene where the batter hits a ball high in the air but also scenes before and after that as a home run event from the video material collectively, and to include these scenes in the digest video.

An object of the present disclosure is to provide an information processing device capable of extracting events in a video material in an appropriate segment where contents of the events can be understood.

### Means for Solving the Problem

According to an example aspect of the present disclosure, there is provided an information processing device including:
an acquisition means configured to acquire a plurality of videos including a video material and a digest video;
a coincident segment detection means configured to detect each coincident segment where the video material and the digest video match with each other in content; and
a training data generation means configured to generate training data from the video material based on the coincident segment.

According to another example aspect of the present disclosure, there is provided an information processing method including:
acquiring a plurality of videos including a video material and a digest video;
detecting each coincident segment where the video material and the digest video match with each other in content; and
generating training data from the video material based on the coincident segment.

According to a further example aspect of the present disclosure, there is provided a recording medium storing a program, the program causing a computer to perform a process including:
acquiring a plurality of videos including a video material and a digest video;
detecting each coincident segment where the video material and the digest video match with each other in content; and
generating training data from the video material based on the coincident segment.

According to an example aspect of the present disclosure, there is provided a n information processing device including:
an acquisition means configured to acquire a video material and event information including time of an event included in the video material; and
an event segment detection means configured to detect each event segment from the video material based on the video material and the event information, by using a trained model which detects the event segment.

According to another example aspect of the present disclosure, there is provided an information processing method including:
acquiring a video material and event information including time of an event included in the video material; and
detecting each event segment from the video material based on video material and the event information, by using a trained model which detects the event segment.

According to a further example aspect of the present disclosure, there is provided a recording medium storing a program, the program causing a computer to perform a process including:
acquiring a video material and event information including time of an event included in the video material; and
detecting each event segment from the video material based on video material and the event information, by using a trained model which detects the event segment.

### Effect of the Invention

According to the present disclosure, it becomes possible to extract events in a video material in an appropriate segment where contents of the events can be understood.

### BRIEF DESCRIPTION OF THE DRAWINGS

FIG. 1 illustrates a basic concept of a digest generation device.

FIG. 2 illustrates examples of a digest video and an event segment.

FIG. 3 schematically illustrates a basic concept of example embodiments.

FIG. 4 is a block diagram illustrating a hardware configuration of a training device.

FIG. 5 is a diagram for explaining a generation method of training data of an event segment detection model.

FIG. 6 is a block diagram illustrating a functional configuration of the training device.

FIG. 7 is a flowchart of a training process executed by the training device.

FIG. 8 is a block diagram illustrating a functional configuration of a digest generation device of a first example.

FIG. 9 schematically illustrates a generation method of a digest video in a second example.

FIG. 10 is a block diagram illustrating a functional configuration of a digest generation device of the second example.

FIG. 11 is a flowchart of the digest generation device of the second example.

FIG. 12 schematically illustrates a generation method of a digest video in a third example.

FIG. 13 is a block diagram illustrating a functional configuration of a digest generation device of the third example.

FIG. 14 is a flowchart of a digest generation process of the third example.

FIG. 15 is a block diagram illustrating a functional configuration of an information processing device of a second example embodiment.

FIG. 16 is a flowchart of a process by the information processing device of the second example embodiment.

FIG. 17 is a block diagram illustrating a functional configuration of an information processing apparatus of a third example embodiment.

FIG. 18 is a flowchart of a process by the information processing device of the third example embodiment.

### EXAMPLE EMBODIMENTS

In the following, example embodiments will be described with reference to the accompanying drawings.

<Basic Concept of Digest Generation Device>

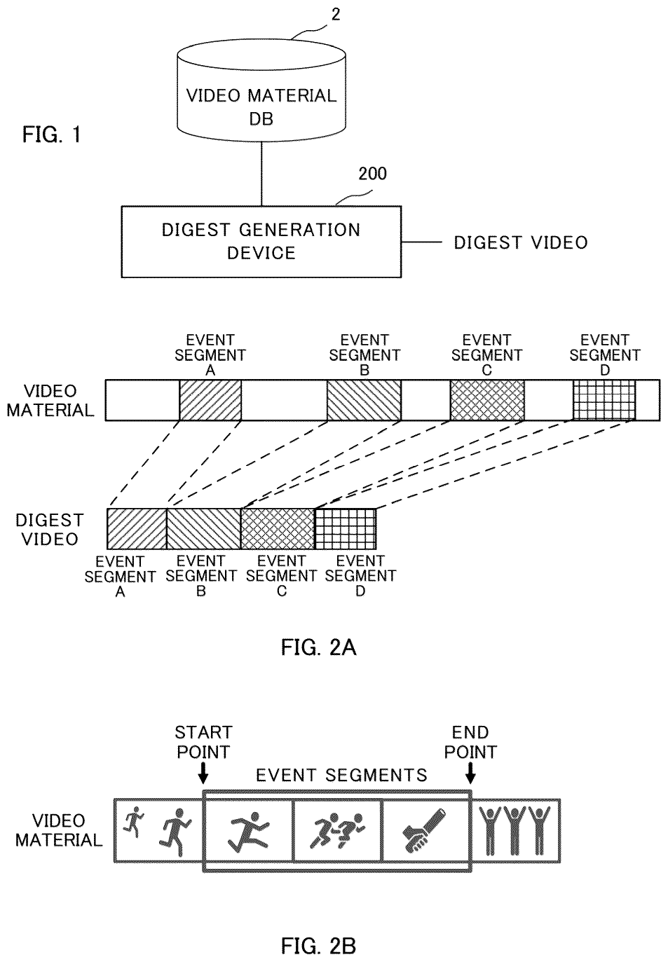

FIG. 1 illustrates a basic concept of a digest generation device. A digest generation device 200 is connected to a video material database (hereinafter, a “database” is referred to as a “DB”)2. The video material DB 2 stores various video materials, that is, video images. The video material may be, for instance, a video such as a television program broadcasted from a broadcasting station, or may be a video distributed by the Internet or the like. Note that the video material may or may not include audio.

The digest generation device 200 generates and outputs the digest video which uses a part of the video material stored in the video material DB 2. The digest video is a video in which scenes where some kind of event occurred in the video material are connected in a time series. As will be described later, the digest generation device 200 detects each event segment from the video material using an event segment detection model which has been trained by the machine learning, and generates the digest video by connecting the event segments in the time series. The event segment detection model is a model for detecting each segment of the event from the video material, for instance, a model using a neural network can be used.

FIG. 2A illustrates an example of the digest video. In the example in FIG. 2A, the digest generation device 200 extracts event segments A to D included in the video material, and connects the extracted event segments in the time series to generate the digest video. Note that the event segments extracted from the video material may be repeatedly used in the digest video depending on contents thereof.

FIG. 2B illustrates an example of the event segment. The event segment is formed by a plurality of frame images corresponding to the scene in which some kind of event occurred in the video material. The event segment is defined by a start point and an end point. Note that instead of the end point, the event segment may be defined using a length of the event segment.

<Basic Principle>

First, the basic principle of the digest generation device will be described according to example embodiments. In a case of creating the digest video from the video material, it is important to appropriately extract each event segment in the video material. For instance, in a case of extracting the part of the batter who hit the home run as an event from the video material of the baseball game, as in the example above, even if only a moment when the batter hits a ball high in the air is clipped as the event, it is difficult for a viewer to understand whether it is the home run or not. Therefore, in this case, it is preferable to extract a series of images from the video material together as the home run event: an image of the batter hitting the ball, an image of the ball rising high and entering an outfield stand, and an image of the batter running for a base hit.

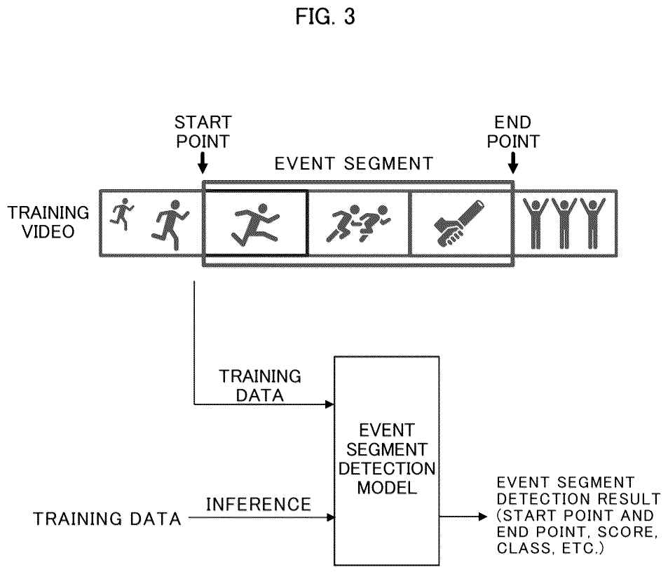

From this viewpoint, in the present embodiments, the event detection model for detecting an event segment is created from the video material. FIG. 3 schematically illustrates the basic principle of the present embodiments. As an overview, first, training data are created using training videos. The training data are data for training the event segment detection model, and include a training video as input data and correct answer data indicating each event segment in the training video. Here, the correct answer data are data indicating a temporal location of each event segment in the training video, and specifically including respective times indicating the start point and the end point of each event segment in the training video. Instead of indicating the event segment by the start point and the end point, an event space may be indicated by the start point and the length of the event segment (time range).

Once the training data are available, the event segment detection model is trained using the training data. Specifically, the event segment detection model detects each event segment from the input training video. The detected event segment is compared with the correct answer data, and the event segment detection model is optimized based on an error between them. Accordingly, the trained event segment detection model can detect the event segment from the input video material.

At a time of an inference, the video material is input to the trained event segment detection model. The event segment detection model detects each event included in the video material as the event segment. A detection result by the event segment detection model includes times indicating the start point and the end point of the event segment in the video material, and a score indicating an event likelihood of a video in the event segment. Also, the detection result of the event segment may include a class of an event name indicating what kind of event the event segment is. The digest video is generated by connecting a plurality of event segments detected in this manner in the time series.

### First Example Embodiment

[Training Device]

First, a training device of the event segment detection model will be described.

(Hardware Configuration)

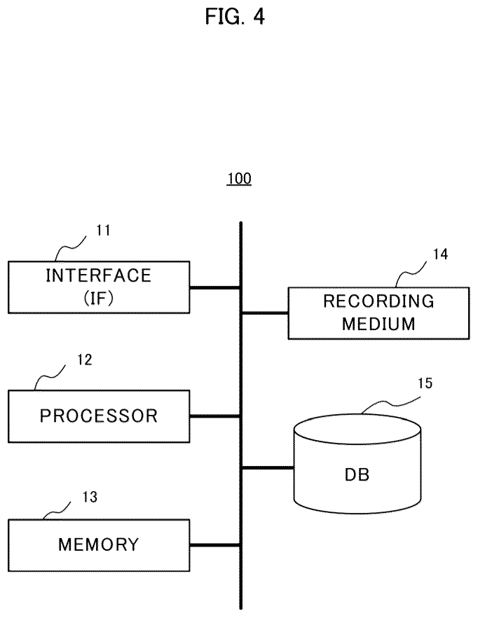

FIG. 4 is a block diagram illustrating a hardware configuration of a training device 100. As illustrated, the training device 100 includes an interface (IF) 11, a processor 12, a memory 13, a recording medium 14, and a database (DB) 15.

The IF 11 inputs and outputs data to and from an external device. Specifically, the training video and an existing digest video are input to the training device 100 via the IF 11.

The processor 12 is a computer such as a CPU (Central Processing Unit) which controls the entire training device 100 by executing programs prepared in advance. Specifically, the processor 12 executes a training process to be described later.

The memory 13 is formed by a ROM (Read Only Memory) and a RAM (Random Access Memory). The memory 13 is also used as a working memory during executions of various processes by the processor 12.

The recording medium 14 is a non-volatile and non-transitory recording medium such as a disk-shaped recording medium, a semiconductor memory, or the like, and is formed to be detachable to the training device 100. The recording medium 14 records various programs to be executed by the processor 12. In a case where the training device 100 performs various processes, the programs recorded on the recording medium 14 are loaded into the memory 13 and executed by the processor 12.

The database 15 stores the training video, existing digest videos, and the like which are input through the IF 11. Also, the database 15 stores information of the event segment detection model to be trained. Note that the training device 100 may include a keyboard, an input section such as a mouse, and a display section such as a liquid crystal display for a creator to provide instructions and inputs.

(Generation Method of Training Data)

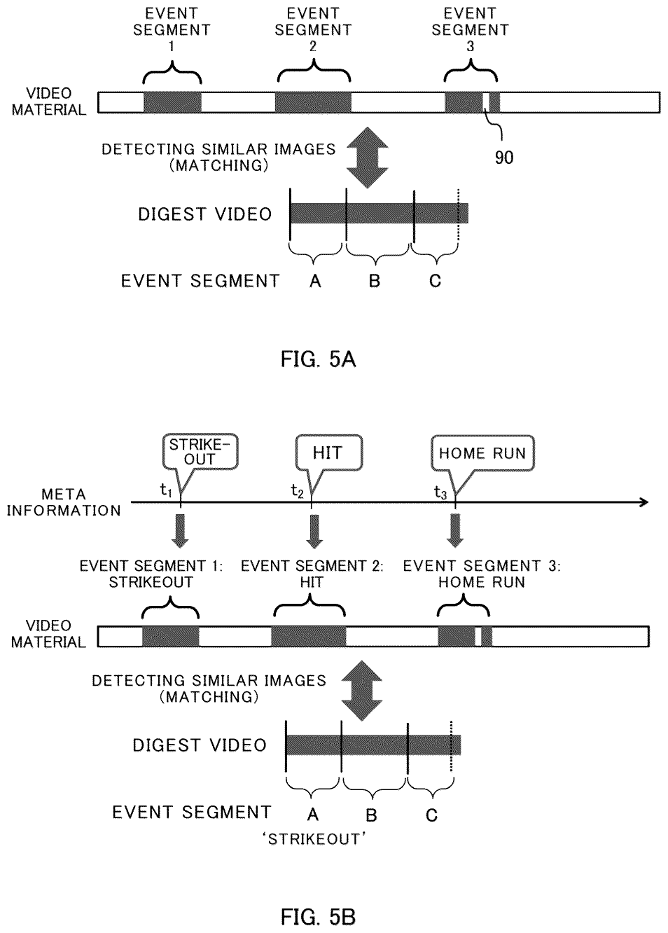

FIG. 5A is a diagram illustrating a generation method of the training data used to train the event segment detection model. First, the existing digest video is prepared. This digest video is a digest video which has already been created to include appropriate contents, and includes a plurality of event segments A to C separated at appropriate points.

The training device 100 performs matching between the video material and the digest, detects each segment having a similar content as the event segment included in the digest video from the video material, and acquires time information of the start point and the end point of the detected event segment. Note that instead of the end point, the time range from the start point may be used. The time information can be a timecode or a frame number in the video material. In the example in FIG. 5A, event segments 1 to 3 are detected from the video material corresponding to the event segments A to C of the digest video.

Note that the training device 100 may be formed such that, even in a case where a slight discrepancy exists in content among the coincident segments where contents correspond to each other between the video material and the digest video, when the segment having the discrepancy is equal to or less than a predetermined time range (for instance, 1 second), the discrepant segment may be combined with a previous coincident segment and a subsequent coincident segment to form a single coincident segment. In the example in FIG. 5A, in the event segment 3 of the video material, there is a discrepant segment 90 which does not match the event segment C in the digest video, but since the time range of the discrepant segment 90 is equal to or less than a predetermined value, it is included in the event segment 3.

The training device 100 may use meta information to add tag information indicating the event name to each event segment in a case where coincident meta information including the time and the event name (event class) of the event included in the video material exists. FIG. 5B illustrates an example in which the tag information is assigned using the meta information. The meta information includes an event name ‘STRIKE OUT’ at a time t₁, an event name ‘HIT’ at a time t₂, and the event name ‘HOME RUN’ at a time t₃. In this case, the training device 100 assigns the tag information ‘STRIKE OUT’ to the event segment 1 detected from the video material, assigns the tag information ‘HIT’ to the event segment 2, and assigns the tag information ‘HOME RUN’ to the event segment 3. The assigned tag information is used as a part of the correct answer data in the training data.

In the example described above, the tag information is assigned to each event segment using the meta information including the event name, but instead, a human may visually check each event forming the digest video and add the tag information to the digest video. In this case, the training device 100 may reflect the tag information assigned to each event segment of the digest video to the event segment of the video material corresponding to the tag information based on a correspondence relationship obtained by the matching of the video material with the digest video. For instance, in the example in FIG. 5B, when the tag information ‘STRIKE OUT’ is assigned to the event segment A of the digest video, the training device 100 may add the tag information ‘STRIKE OUT’ to the event segment 1 of the video material corresponding thereto.

(Functional Configuration)

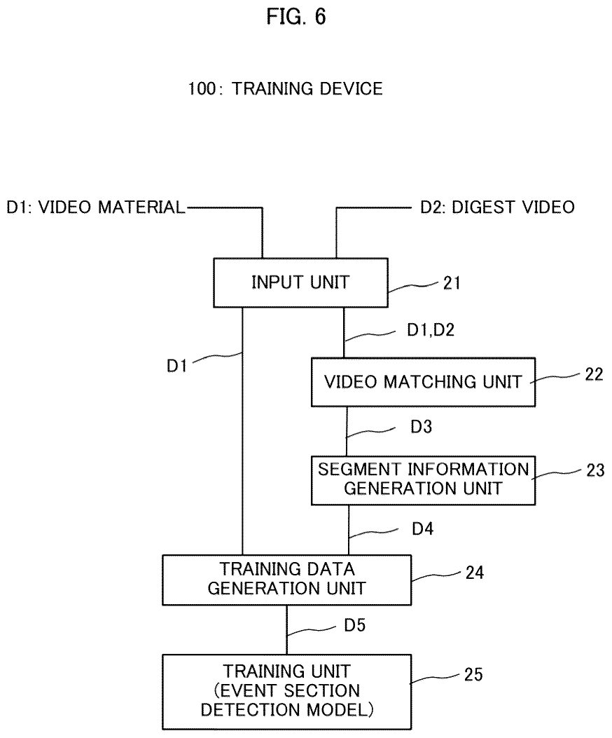

FIG. 6 is a block diagram illustrating a functional configuration of the training device 100. The training device 100 includes an input unit 21, a video matching unit 22, a segment information generation unit 23, a training data generation unit 24, and a training unit 25.

A video material D1 and a digest video D2 are input to the input unit 21. The video material D1 corresponds to an original video for the training data. The input unit 21 outputs the video material D1 to the training data generation unit 24, and outputs the video material D1 and the digest video D2 to the image matching unit 22.

As illustrated in FIG. 5A, the image matching unit 22 performs the matching between the video material D1 and the digest video D2, generates coincident segment information D3 indicating a coincident segment in which the video contents are matched, and outputs the coincident segment information D3 to the segment information generation unit 23.

The segment information generation unit 23 generates segment information to be a series of scenes based on the coincident segment information D3. In detail, the segment information generation unit 23 determines each coincident segment as the event segment, and outputs segment information D4 of the event segment to the training data generation unit 24 with respect to a certain coincident segment which is equal to or more than a predetermined time range. Moreover, as described above, in a case where a time of the discrepant segment between two continuous coincident segments is equal to or less than a predetermined threshold value, the segment information generation unit 23 determines the whole of the previous coincident segment, the subsequent coincident segment, and the discrepant segment thereof as one event subsequent. The segment information D4 includes time information indicating the event segment in the video material D1. Specifically, the time information indicating the event segment includes the times of the start point and the end point of the event segment or the time of the start point and the time range of the event segment.

The training data generation unit 24 generates the training data based on the video material D1 and the segment information D4. In detail, the training data generation unit 24 clips a part corresponding to the event segment indicated by the segment information D4 from the video material D1 to generate a training vide. Specifically, the training data generation unit 24 clips a video from the video material D1 with respective certain ranges before and after the event segment. In this case, the training data generation unit 24 may randomly determine respective ranges to be designated before and after the event segment, or may apply the respective ranges specified in advance. The respective range added before and after the event segment may be the same length or may be a different length. In addition, the training data generation unit 24 sets the time information of the event segment indicated by the segment information D4 as the correct answer data. Accordingly, the training data generation unit 24 generates training data D5 which correspond to a set of the training video and the correct answer data for each event segment included in the video material D1, and outputs the training data to the training unit 25.

The training unit 25 trains the event segment detection model using the training data D5 which are generated by the training data generation unit 24. In detail, the training unit 25 inputs the training video to the event segment detection model, compares the output of the event segment detection model with the correct answer data, and optimizes the event segment detection model based on the error. The training unit 25 trains the event segment detection model using a plurality of pieces of the training data D5 generated from a plurality of video materials, and terminates the training when a predetermined termination condition is provided. The trained event segment detection model thus obtained can appropriately detect the event segment from the input video material and output the detection result including the time information indicating the segment, the score of the event likelihood, the tag information indicating the event name, and the like.

In the configuration described above, the input unit 21 is an example of an acquisition means, the image matching unit 22 and the segment information generation unit 23 correspond to an example of a matching segment detection means, the training data generation unit 24 is an example of a training data generation means, and the training unit 25 is an example of a training means. Moreover, the meta information is an example of the event information.

(Training Process)

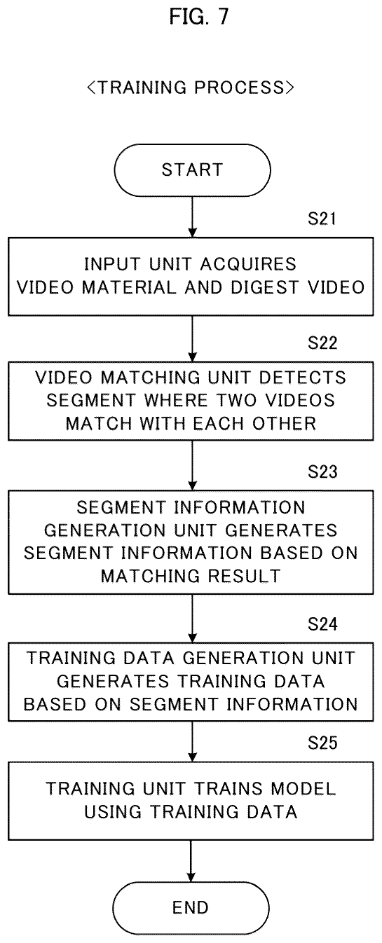

FIG. 7 is a flowchart of a training process performed by the training device 100. This training process is realized by the processor 12 illustrated in FIG. 4, which executes programs prepared in advance and operates as each of elements depicted in FIG. 6.

First, the input unit 21 acquires the video material D1 and the digest video D2 (step S21). Next, the video matching unit 22 detects the coincident segment in which the video material D1 and the digest video D2 match to each other in content, and outputs the coincident segment information D3 (step S22). Subsequently, the segment information generation unit 23 determines the event segment included in the video material D1 based on the matching segment obtained as the matching result, and outputs the segment information D4 (step S23).

Next, the training data generation unit 24 generates the training data D5 based on the video material D1 and the segment information D4, and outputs to the training unit 25 (step S24). Subsequently, the training unit 25 trains the event segment detection model using the training data D5 (step S25). Accordingly, the trained event segment detection model is generated.

[Digest Generation Device]

Next, a digest generation device using the above-described trained event segment detection model will be described. Note that the hardware configuration of the digest generation device is basically the same as that of the training device 100 illustrated in FIG. 4. However, the interface 11 receives the video material which is used as a basis for creating the digest video, and outputs the generated digest video.

### (1) First Example

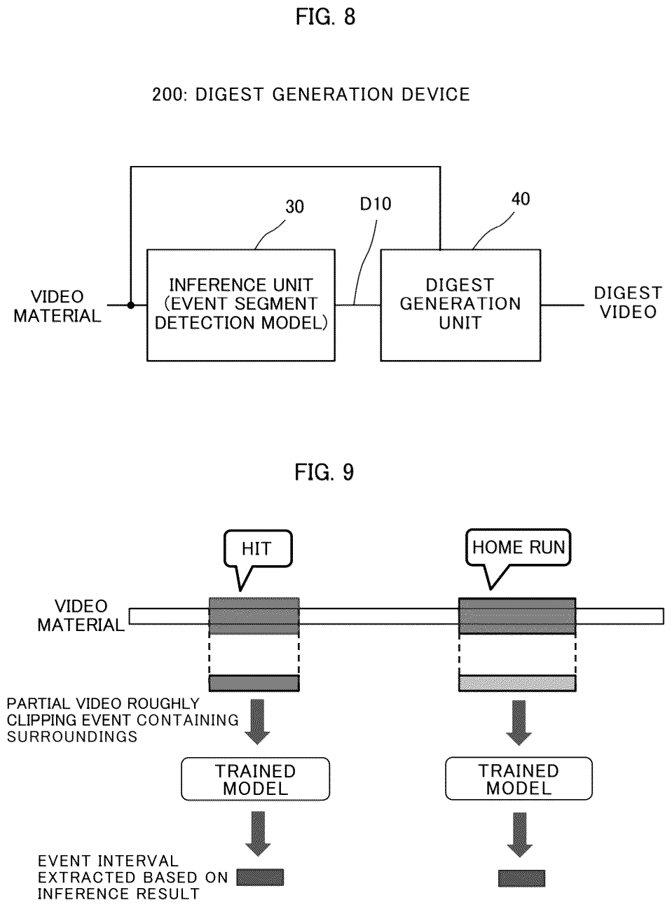

First, a first example of the digest generation device will be described. FIG. 8 is a block diagram illustrating a functional configuration of the digest generation device 200 according to the first example. The digest generation device 200 includes an inference unit 30 and a digest generation unit 40.

The video material to be created for the digest video is input to the inference unit 30. The inference unit 30 performs the inference using the trained event segment detection model by the training device 100 described above. In detail, the inference unit 30 detects the event segment from the video material using the event segment detection model, and outputs a detection result D10 to the digest generation unit 40. The detection result D10 includes the time information of the plurality of event segments detected from the video material, the score of the event likelihood, the tag information, and the like.

The video material and the detection result D10 by the inference unit 30 are input into the digest generation unit 40. The digest generation unit 40 clips the video of each event segment indicated by the detection result D10 from the video material, and generates the digest video in the time series. In this manner, it is possible to generate the digest video using the trained event segment detection model.

### (2) Second Example

Next, a second example of the digest generation device will be described. In the second example, the digest generation is efficiently performed using the meta information. FIG. 9 schematically illustrates a method for generating the digest video by a digest generation device 200x according to the second example. In the second example, instead of inputting the entire video material into the event segment detection model, only a video of a portion of the video material which is predicted to include an event is input into the event segment detection model.

In detail, the digest generation device 200x detects surroundings of the event segment from the video material using the meta information. As described above, the meta information includes the time of each event segment included in the video material. Therefore, the digest generation device 200x roughly clips the event containing the surroundings thereof included in the video material based on the meta information, generates a partial video, and inputs the partial video to the trained event segment detection model. In this manner, since the digest generation device 200x only needs to perform the inference process for the partial video in which the event is predicted to be included among the video materials, the inference process can be made more efficient.

(Functional Configuration)

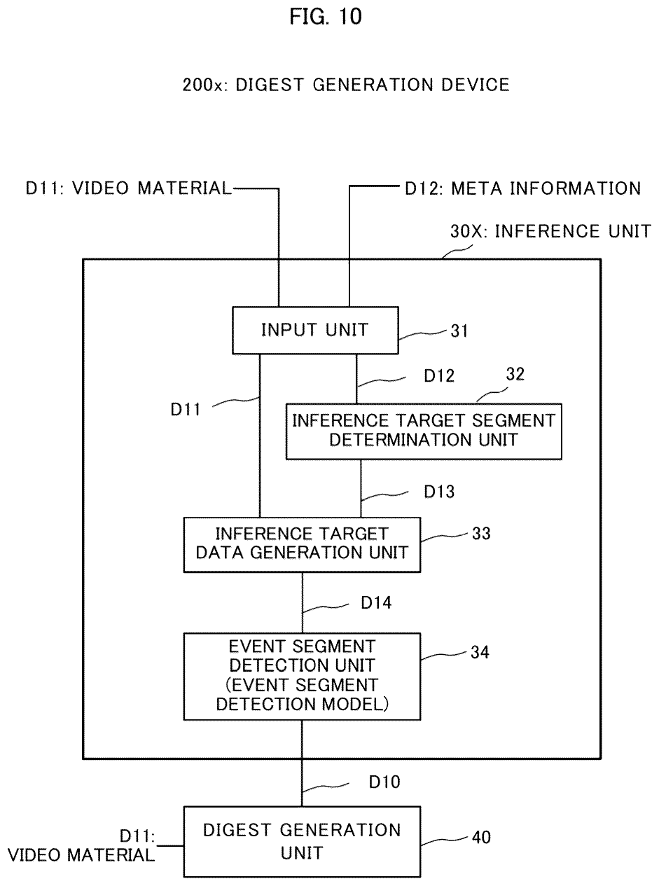

FIG. 10 is a block diagram illustrating a functional configuration of the digest generation device 200x according to a second example. The digest generation device 200x includes an inference unit 30x and the digest generation unit 40. The inference unit 30x includes an input unit 31, an inference target segment determination unit 32, an inference target data generation unit 33, and an event segment detection unit 34.

A video material D11 and meta information D12 are input to the input unit 31. The input unit 31 outputs the video material D11 to the inference target data generation unit 33, and outputs the meta information D12 to the inference target segment determination unit 32.

The inference target segment determination unit 32 determines the inference target segment based on the meta information D12. The inference target segment illustrates a portion of the video material which is predicted to include the event and corresponds to the segment of the partial video described with reference to FIG. 9. In one example, the inference target segment determination unit 32 determines respective segments of predetermined time ranges before and after the event based on the time of the event segment included in the meta information D12, as inference target segments. In this case, the time ranges before and after the event may be different to each other. In general, the time of the event included in the meta information indicates the approximate start time of the event, and therefore, the time range before the event may be a time corresponding to an error in the time of the event, and the time range after the event may be a required time of the event occurring in the video material. Moreover, the time ranges before and after the event may be determined according to a genre and a content of the video material.

Moreover, as another example, in a case where the video materials are videos which are created by editing videos of a plurality of cameras, the inference target segment determination unit 32 may determine the inference target segment using the switching timing of the cameras in the video material, that is, a shot boundary. In detail, the inference target segment determination unit 32 may determine segments each including a predetermined number of shot boundaries (n shot boundaries) before and after the event as the inference target segment based on the time of the event included in the meta information D12. In this case, the predetermined number n may be different before and after the event. The predetermined number n before and after the event may be determined according to the genre and the content of the video material. The inference target segment determination unit 32 outputs inference target segment information D13 indicating the determined inference target segment to the inference target data generation unit 33.

The inference target data generation unit 33 generates inference target data D14 based on the video material D11 and the inference target segment information D13, and outputs the inference target data D14 to the event segment detection unit 34. In detail, the inference target data generation unit 33 generates a partial video corresponding to the inference target segment in the video material D11 as the inference target data D14. The inference target data D14 corresponds to a partial video in which an event portion depicted in FIG. 9 is roughly clipped.

The event segment detection unit 34 detects the event segment from the inference target data D14 using the trained event segment detection model, and outputs the detection result D10 to the digest generation unit 40. The digest generation unit 40 is the same as the first example, and generates the digest video using the video material D11 and the detection result D10.

In the configuration described above, the input unit 31 is an example of an acquisition means, and the inference unit 30x is an example of an event segment detection means. The inference target segment determination unit 32 is an example of an inference target segment determination means, the inference target data generation unit 33 is an example of an inference target data generation means, the event segment detection unit 34 is an example of an inference means, and the digest generation unit 40 is an example of a digest generation means.

(Digest Generation Process)

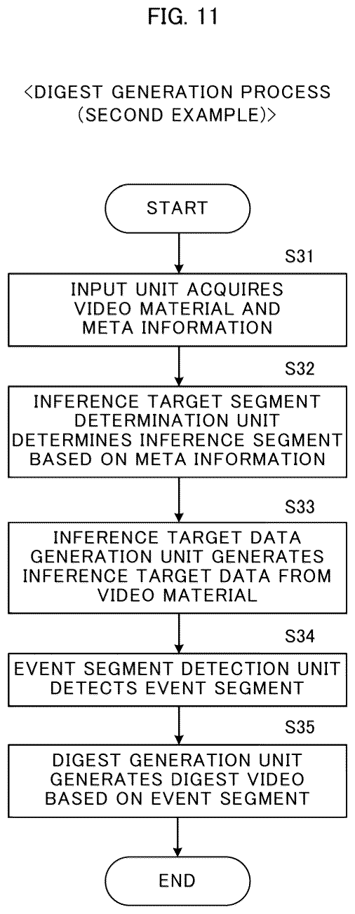

FIG. 11 is a flowchart of a digest generation process performed by the digest generation device 200x according to the second example. This digest generation process is realized by the processor 12 depicted in FIG. 4, which executes programs prepared in advance and operates as each of elements depicted in FIG. 10.

First, the input unit 31 acquires the video material D11 and the meta information D12 (step S31). The inference target segment determination unit 32 determines the inference target segment based on the meta information D12, and outputs the inference target segment information D13 to the inference target data generation unit 33 (step S32). Next, the inference target data generation unit 33 generates the inference target data D14 based on the video material D11 and the inference target segment information D13, and outputs the inference target data D14 to the event segment detection unit 34 (step S33).

Next, the event segment detection unit 34 detects the event segment from the inference target data D14 using the trained event segment detection model, and outputs the detection result D10 to the digest generation unit 40 (step S34). Subsequently, the digest generation unit 40 generates the digest video based on the video material D11 and the detected result D10 (step S35). After that, the process is terminated.

As described above, according to the digest generation device 200x of the second example, since only the video portion which is predicted to include the event among the video materials is set to be processed by the inference unit 30x, it is possible to improve efficiency of the process for detecting the event segment.

### (3) Third Example

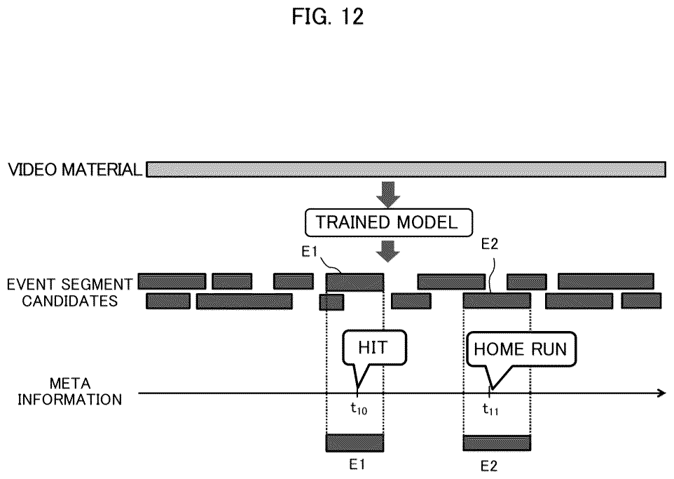

Next, a third example of the digest generation device will be described. In the third example, the meta information are also used to perform the digest generation. FIG. 12 schematically illustrates a generation method of the digest video by a digest generation device 200y according to the third example. In the third example, the entire video material is input to the event segment detection model. The event segment detection model outputs a plurality of event segments as event segment candidates. Note that as illustrated in FIG. 12, the event segment model may detect a plurality of event segment candidates corresponding to the same time in the video material. Therefore, the digest generation device 200y acquires each event time from the meta information and adopts the event segment candidates corresponding to respective times of the event segments as final event segments.

For instance, in the example in FIG. 12, the meta information includes the event “HIT” in a time t₁₀ and the event “HOME RUN” in a time t₁₁. Therefore, the digest generation device 200y selects, among the plurality of event segment candidates, an event segment candidate E1 corresponding to the time t₁₀ and an event segment candidate E2 corresponding to the time t₁₁ as the final event segments.

In a case where there are a plurality of event segment candidates corresponding to respective event times extracted from the meta information, the digest generation device 200y may select one having the highest score for the event likelihood included in the detection result of the event segment detection model. Alternatively, in a case where there is a predetermined condition for the length or the time range of the event segment, the digest generation device 200y may select each event segment candidate which matches that condition. For instance, in a case where the total time of the digest video to be generated is determined, the digest generation device 200y may select each event segment candidate so that the whole time corresponds to the total time. Moreover, in a case where the condition of the time range for one event segment is determined (that is, T₁ seconds or more and T₂ seconds or less), the digest generation device 200y may select the event segment candidate most suitable for the condition among the plurality of event segment candidates corresponding to the same event time. Note that in this case, the condition of the time range of one event segment can be determined based on the genre and the content of the video material.

(Functional Configuration)

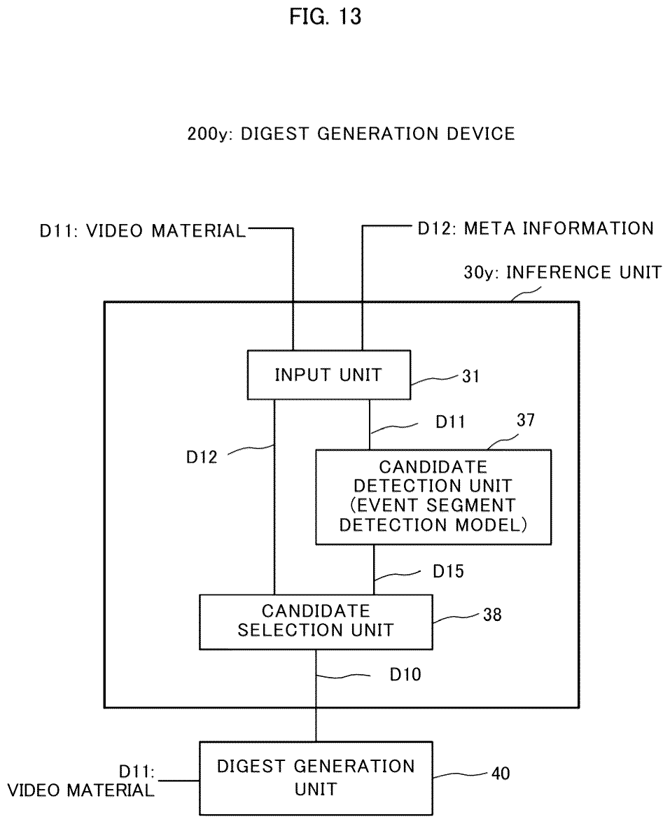

FIG. 13 is a block diagram illustrating a functional configuration of the digest generation device 200y according to the third example. The digest generation device 200y includes an inference unit 30y and the digest generation unit 40. The inference unit 30y includes the input unit 31, a candidate detection unit 37, and a candidate selection unit 38.

The video material D11 and the meta information D12 are input to the input unit 31. The input unit 31 outputs the video material D11 to the candidate detection unit 37, and outputs the meta information D12 to the candidate selection unit 38.

The candidate detection unit 37 detects each event segment candidate D15 from the video material D11 using the trained event segment detection model, and outputs the detected event segment candidate D15 to the candidate selection unit 38. The candidate selection unit 38 acquires the event time from the meta information D12, selects the event segment candidates corresponding to the event time among the plurality of event segment candidates D15, and outputs the detection result D10 to the digest generation unit 40. The digest generation unit 40 is the same as the first embodiment, and generates the digest video using the video material D11 and the detection result D10.

In the configuration described above, the input unit 31 is an example of an acquisition means, and the inference unit 30y is an example of an event segment detection means. Moreover, the candidate detection unit 37 is an example of the candidate detection means, the candidate selection unit 38 is an example of the candidate selection means, and the digest generation unit 40 is an example of the digest generation means.

(Digest Generation Process)

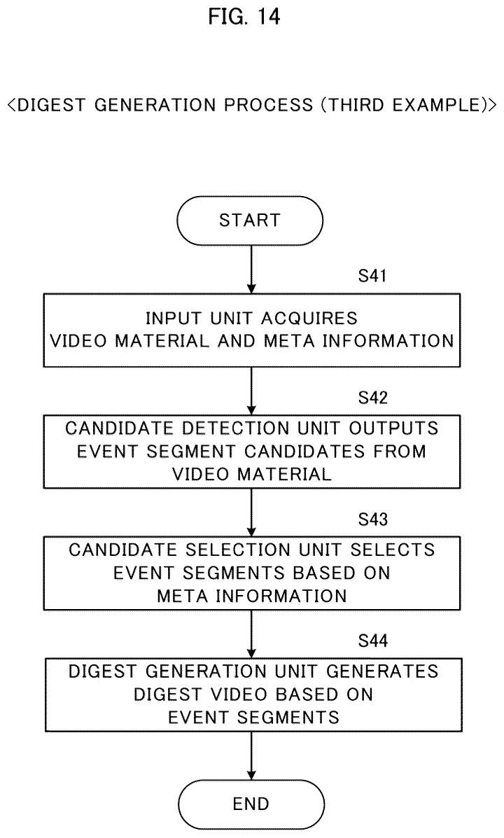

FIG. 14 is a flowchart of a digest generation process which is executed by the digest generation device 200y according to the third example. This digest generation process is realized by the processor 12 depicted in FIG. 4, which executes programs prepared in advance and operates as each of elements depicted in FIG. 13.

First, the input unit 31 acquires the video material D11 and the meta information D12 (step S41). The candidate detection unit 37 detects the event segment candidates D15 from the video material using the trained event segment detection model, and outputs the event segment candidates D15 to the candidate selection unit 38 (step S42). Next, the candidate selection unit 38 acquires the event time from the meta information D12, selects each event segment candidate corresponding to the event time as the detection result D10, and outputs the detection result D10 to the digest generation unit 40 (step S43). Subsequently, the digest generation unit 40 generates the digest video based on the video material D11 and the detection result D10 (step S44). After that, the digest generation process is terminated.

As such, according to the digest generation device 200y of the third example, it is possible to select an appropriate event segment candidate based on the meta information from the plurality of event segment candidates detected from the video material, and to create the digest video.

### Second Example Embodiment

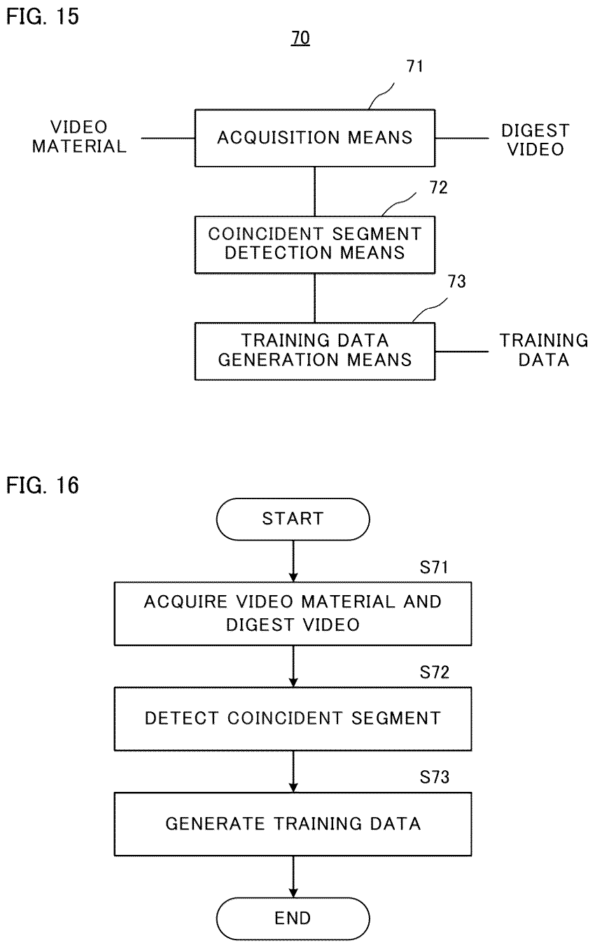

Next, a second example embodiment of the present disclosure will be described. FIG. 15 is a block diagram illustrating a functional configuration of an information processing device according to the second example embodiment. As illustrated, an information processing device 70 includes an acquisition means 71, a coincident segment detection means 72, and a training data generation means 73.

FIG. 16 is a flowchart of a process performed by the information processing device 70. The acquisition means 71 acquires a plurality of videos including the video material and the digest video (step S71). The coincident segment detection means 72 detects each coincident segment in which the video material and the digest video match with each other in content (step S72). The training data generation means 73 generates training data from the video material based on the coincident segment (step S73).

### Third Example Embodiment

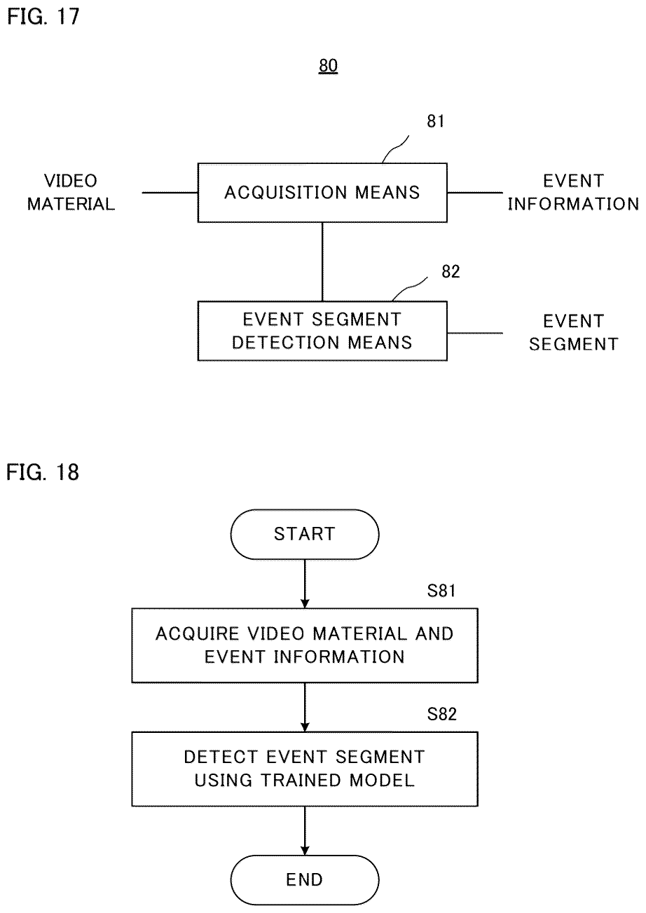

Next, a third example embodiment of the present disclosure will be described. FIG. 17 is a block diagram illustrating a functional configuration of an information processing device according to the third example embodiment. As illustrated, an information processing device 80 includes an acquisition means 81 and an event segment detection means 82.

FIG. 18 is a flowchart of a process performed by the information processing device 80. The acquisition means 81 acquires the video material and the event information including the time of the event included in the video material (step S81). The event segment detection means 82 detects each event segment from the video material based on the video material and the event information using the trained model for detecting the event segment (step S82).

A part or all of the example embodiments described above may also be described as the following supplementary notes, but not limited thereto.

(Supplementary Note 1)

An information processing device comprising:
an acquisition means configured to acquire a plurality of videos including a video material and a digest video;
a coincident segment detection means configured to detect each coincident segment where the video material and the digest video match with each other; and
a training data generation means configured to generate training data from the video material based on the coincident segment.

(Supplementary Note 2)

The information processing device according to supplementary note 1, wherein the training data generation means generates training data in which a portion corresponding to the coincident segment of the video material is input as training input data and time information indicating time of the coincident segment in the video material is used as correction answer data.

(Supplementary Note 3)

The information processing device according to supplementary note 1 or 2, wherein the coincident segment detection means detects continuous coincident segments as one coincident segment in a case where a time interval between the continuous coincident segments is equal to or less than a predetermined value.

(Supplementary Note 4)

The information processing device according to supplementary note 2 or 3, wherein
the acquisition means acquires event information including time and a name of an event included in the digest video, and
the training data generation means includes the name of the event included in the event information as tag information.

(Supplementary Note 5)

The information processing device according to any one of supplementary notes 1 to 4, further comprising a training means configured to train a model which detects each event segment from the video material, by using the training data.

(Supplementary Note 6)

An information processing method comprising:
acquiring a plurality of videos including a video material and a digest video;
detecting each coincident segment where the video material and the digest video match with each other in content; and
generating training data from the video material based on the coincident segment.

(Supplementary Note 7)

A recording medium storing a program, the program causing a computer to perform a process comprising:
acquiring a plurality of videos including a video material and a digest video;
detecting each coincident segment where the video material and the digest video match with each other in content; and
generating training data from the video material based on the coincident segment.

(Supplementary Note 8)

An information processing device comprising:
an acquisition means configured to acquire a video material and event information including time of an event included in the video material; and
an event segment detection means configured to detect each event segment from the video material based on the video material and the event information, by using a trained model which detects the event segment.

(Supplementary Note 9)

The information processing device according to supplementary note 8, wherein the event segment detection means further includes
an inference target segment determination means configured to determine an inference target segment in the video material based on the event information;
an inference target data generation means configured to generate inference target data by clipping the inference target segment from the video material; and
an inference means configured to detect the event segment from the inference target data by using the trained model.

(Supplementary Note 10)

The information processing device according to supplementary note 8, wherein the event segment detection means includes
a candidate detection means configured to detect each event segment candidate from the video material, by using the trained model; and
a selection means configured to select each event segment from one or mor event segment candidates based on the event information.

(Supplementary Note 11)

The information processing device according to supplementary note 10, wherein the selection means selects, as the event segment, an event segment candidate having the highest score of an inference by the trained model, when there are a plurality of event segment candidates for the same time.

(Supplementary Note 12)

The information processing device according to supplementary note 10, wherein the selection means selects, as the event segment, an event segment candidate being the most suitable for a time condition of a predetermined event segment, when there are a plurality of event segment candidates for the same time.

(Supplementary Note 13)

The information processing device according to any one of supplementary notes 8 to 12, further comprising a digest generation means configured to generate a digest video by connecting videos of event segments in a time series based on the video material and each event segment detected by the event segment detection means.

(Supplementary Note 14)

An information processing method comprising:
acquiring a video material and event information including time of an event included in the video material; and
detecting each event segment from the video material based on video material and the event information, by using a trained model which detects the event segment.

(Supplementary Note 15)

A recording medium storing a program, the program causing a computer to perform a process comprising:
acquiring a video material and event information including time of an event included in the video material; and
detecting each event segment from the video material based on video material and the event information, by using a trained model which detects the event segment.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

12 Processor
21, 31 Input unit
22 Video matching unit
23 Segment information generation unit
24 Training data generation unit
25 Training unit
30, 30x, 30y Inference unit
32 Inference target segment determination unit
33 Inference target data generation unit
34 Event segment detection unit
37 Candidate detection unit
38 Candidate selection unit
40 Digest generation unit
100 Training device
200, 200x, 200y Digest generation device

What is claimed is:

1. An information processing device comprising:
a memory storing instructions; and
one or more processors configured to execute the instructions to:
acquire a plurality of videos including a video material and a digest video;
detect each coincident segment where the video material and the digest video match with each other in content; and
generate training data from the video material based on the coincident segment.

2. The information processing device according to claim 1, wherein the processor generates training data in which a portion corresponding to the coincident segment of the video material is input as training input data and time information indicating time of the coincident segment in the video material is used as correction answer data.

3. The information processing device according to claim 1, wherein the processor detects continuous coincident segments as one coincident segment in a case where a time interval between the continuous coincident segments is equal to or less than a predetermined value.

4. The information processing device according to claim 2, wherein
the processor acquires event information including time and a name of an event included in the digest video, and
the processor includes the name of the event included in the event information as tag information.

5. The information processing device according to claim 1, wherein the processor is further configured to train a model which detects each event segment from the video material, by using the training data.

6. An information processing method comprising:
acquiring a plurality of videos including a video material and a digest video;
detecting each coincident segment where the video material and the digest video match with each other in content; and
generating training data from the video material based on the coincident segment.

7. A non-transitory computer-readable recording medium storing a program, the program causing a computer to perform the information processing method according to claim 6.

8. An information processing device comprising:
a memory storing instructions; and
one or more processors configured to execute the instructions to:
acquire a video material and event information including time of an event included in the video material; and
detect each event segment from the video material based on the video material and the event information, by using a trained model which detects the event segment.

9. The information processing device according to claim 8, wherein in order to detect the event segment, the processor is further configured to
determine an inference target segment in the video material based on the event information;
generate inference target data by clipping the inference target segment from the video material; and
detect the event segment from the inference target data by using the trained model.

10. The information processing device according to claim 8, wherein in order to detect the event segment, the processor is further configured to
detect each event segment candidate from the video material, by using the trained model; and
select each event segment from one or more event segment candidates based on the event information.

11. The information processing device according to claim 10, wherein the processor selects, as the event segment, an event segment candidate having the highest score of an inference by the trained model, when there are a plurality of event segment candidates for the same time.

12. The information processing device according to claim 10, wherein the processor selects, as the event segment, an event segment candidate being the most suitable for a time condition of a predetermined event segment, when there are a plurality of event segment candidates for the same time.

13. The information processing device according to claim 8, further comprising a digest generation means configured to generate a digest video by connecting videos of event segments in a time series based on the video material and each event segment detected by the event segment detection means.

14. An information processing method performed by the information processing device according to claim 8.

15. A non-transitory computer-readable recording medium storing a program, the program causing a computer to perform the information processing method according to claim 14.
